(19) United States
(12) Patent Application Publication
(10) Pub. No.: US 2002/0161872 A1
(43) Pub. Date: Oct. 31, 2002

(54) Network management

(76) Inventors: Thue M. Pontoppidan, Lyngby (DK); Esben Carlsen, Taastrup (DK)

Correspondence Address: FISH & RICHARDSON, PC, 4350 LA JOLLA VILLAGE DRIVE, SUITE 500, SAN DIEGO, CA, 92122, US

(21) Appl. No.: 09/843,170

(22) Filed: Apr. 26, 2001

(51) Int. Cl. G06F 15/173; G06F 15/16

(52) U.S. Cl. 709/223; 709/246

(57) ABSTRACT

A method for receiving on a wireless application protocol terminal a user interface configured to permit management of a network device, interacting with the user interface to send a request to a wireless application protocol device manager configured to manage a network device based on the request, and receiving on the terminal a response from the device manager.

### TECHNICAL FIELD

This invention relates to network management.

### BACKGROUND

Network administrators typically use network management software as a tool to manage networked computer systems. Simple Network Management Protocol (SNMP) is a well-known protocol for network management software.

A network of computer equipment may be accessed from a remote location using a remote access server (RAS). The RAS enables a remote user to access the network using a computer and a modem connected to the public telephone network by a telephone line. Alternatively, a remote user can access the network of computers using a data-capable cellular device to establish a telephone connection.

Wireless Application Protocol (WAP) has become a standard for the presentation and delivery of wireless information and telephony services on mobile phones and other wireless terminals. The Wireless Markup Language (WML), is a tag-based document language adhering to XML standards and optimized for specifying presentation and user interaction on limited capability devices such as telephones and other wireless mobile terminals. WML is used with WAP in the same way as HyperText Markup Language (HTML) is used with HyperText Transfer Protocol (HTTP).

### DESCRIPTION OF DRAWINGS

FIG. 1 is an illustration of a network of computers that could be managed using a WAP terminal.

FIG. 2 is a block diagram illustrating a WAP device manager interacting with a local area network switch and a WAP terminal.

FIG. 3 is a method for managing a network device from a WAP terminal.

FIG. 4 is a method for a network device to interact with a WAP device manager.

FIG. 5 is a method for permitting a WAP terminal to manage a network device.

### DETAILED DESCRIPTION

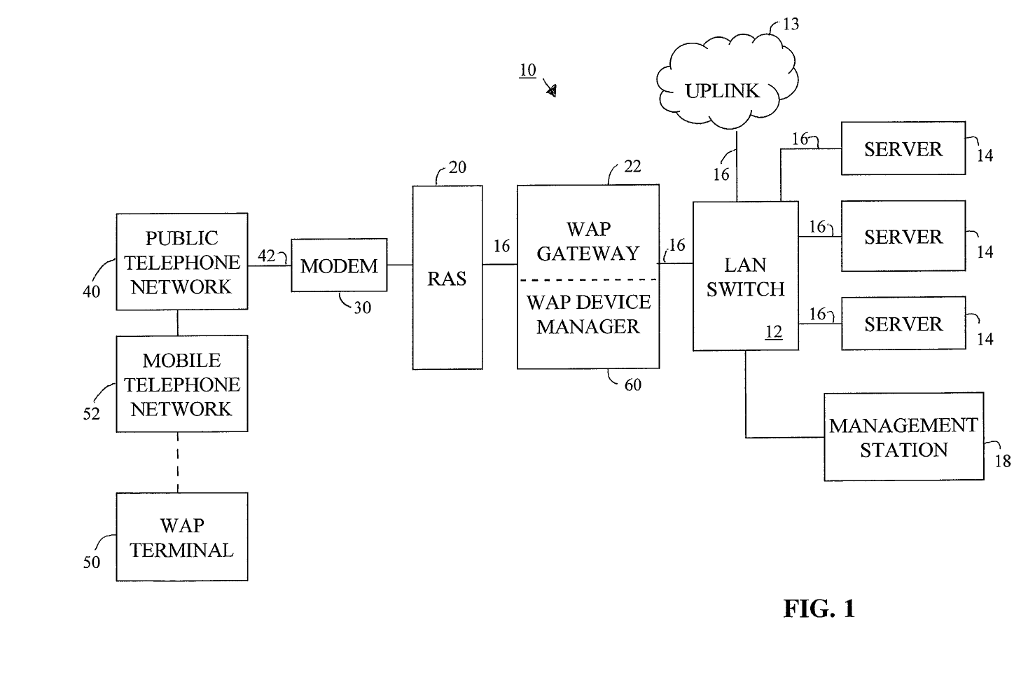

In FIG. 1, local area network (LAN) 10 is configured to allow a network administrator to monitor and configure LAN 10 from WAP device 50. LAN 10 includes at least one network device manageable by SNMP, such as a switch, hub, router, or bridge for example. In FIG. 1, the network device is an SNMP-manageable LAN switch 12.

LAN 10 includes server 14 connected to LAN switch 12 by network medium 16. Server 14 could be, for example, a personal computing system, a web server, a file server, or an application server. LAN switch 12 may be connected in another network configuration represented by network uplink 13, which could be a backbone network, an intranet, a wide area network (WAN), or the Internet.

In addition to LAN switch 12 and server 14, LAN 10 includes a management station 18 connected to LAN switch 12 by network medium 16. A network administrator uses management station 18 to monitor and configure LAN switch 12, for example by downloading a java applet from LAN switch 12. The network administrator could use the applet to send SNMP-compliant requests to LAN switch 12 and receive SNMP-compliant responses from LAN switch 12. The applet could be run on a web browser. In other examples, element manager software, such as Intel's Device View, or enterprise management software, such as HP Openview, available from Hewlett-Packard Co., Palo Alto, Calif., are loaded on management station 18 and can interact with LAN switch 12 using the java applet downloaded from it. A network administrator must be present at management station 18 to monitor or configure LAN 10.

LAN 10 includes a remote access server (RAS) 20 connected to LAN switch 12 by network medium 16 for accessing LAN 10 from a remote location. RAS 20 connects LAN 10 to a public telephone network 40 through modem 30 and contains software permitting remote access to LAN 10.

RAS 20 tunnels traffic between the public telephone network and LAN 10, which could use the Transmission Control Protocol over Internet Protocol (TCP/IP). On the LAN side of RAS 20, the data is transferred by the User Datagram Protocol (UDP). On the telephone network side of RAS 20, data transmitted on the public telephone network 40 and mobile telephone network 52 are carried through a Point-To-Point Protocol (PPP) “tunnel.”

WAP gateway 22 is connected to LAN switch 12 and to modem 30 through RAS 20. In some examples, WAP gateway 22 could be physically installed on the same machine as RAS 20 while, in other examples, WAP gateway 22 could be installed on a dedicated machine.

WAP terminal 50 is a wireless handheld device capable of communication according to WAP. In one example, WAP terminal 50 could be a mobile telephone, such as the Nokia 7110, available from Nokia Corp., Keilalahdentie, Finland. In another example, WAP terminal 50 could be a wireless personal data assistant, such as the Ericsson MC 218, available from Ericsson, Inc., North American Headquarters, Richardson, Tex.

WAP gateway 22 encodes and decodes data transferred to and from WAP terminal 50. Encoding and decoding the data minimizes the transmission resources necessary for WAP terminal 50 to communicate with WAP gateway 22 and minimizes the computing resources required by WAP terminal 50 to process the data. One example of a WAP gateway is Activ Server 2.0 Professional Edition available from Nokia Corp. Keilalahdentie, Finland.

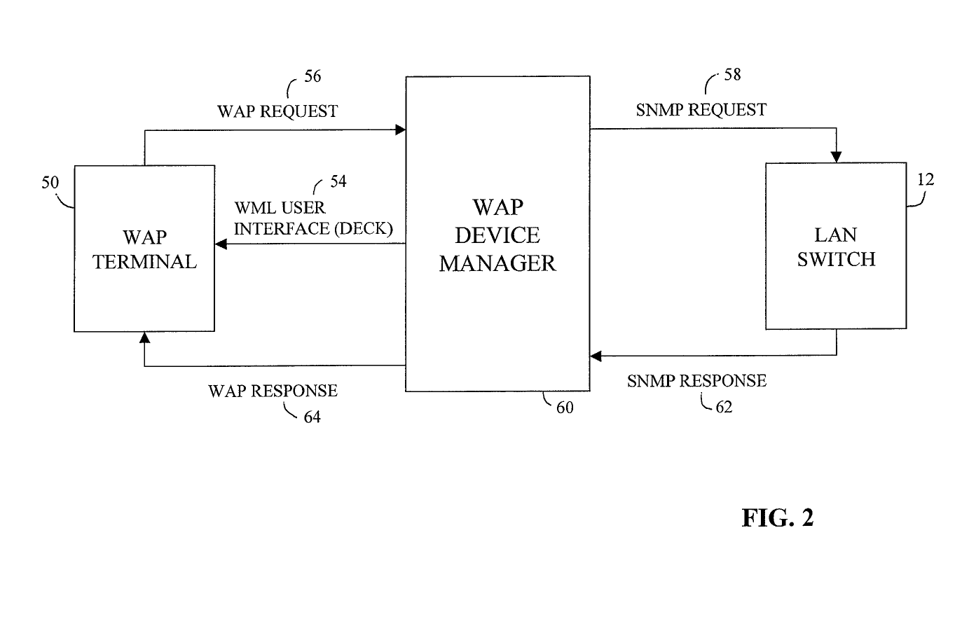

WAP gateway 22 may include a WAP device manager 60 (FIG. 2) allowing a network administrator to send SNMP requests to and receive SNMP responses from LAN switch 12 using WAP terminal 50, as shown in FIG. 2. WAP terminal 50 uses mobile telephone network 52 and public telephone network 40 to establish a dial-up connection to WAP gateway 22 through modem 30 and RAS 20.

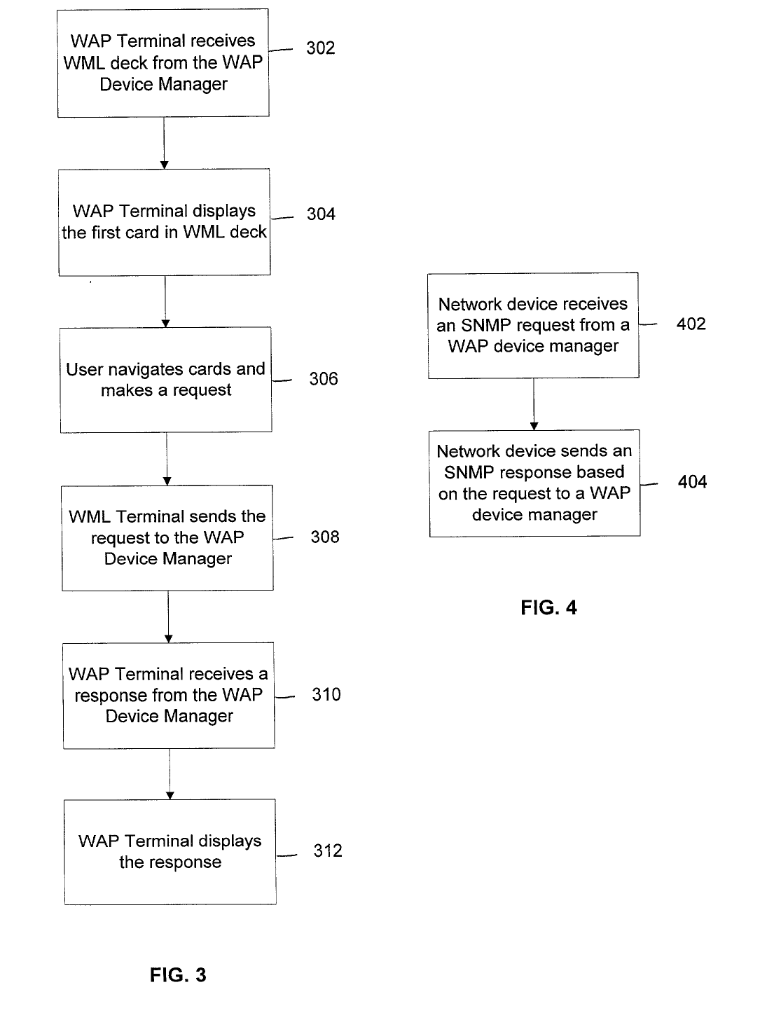

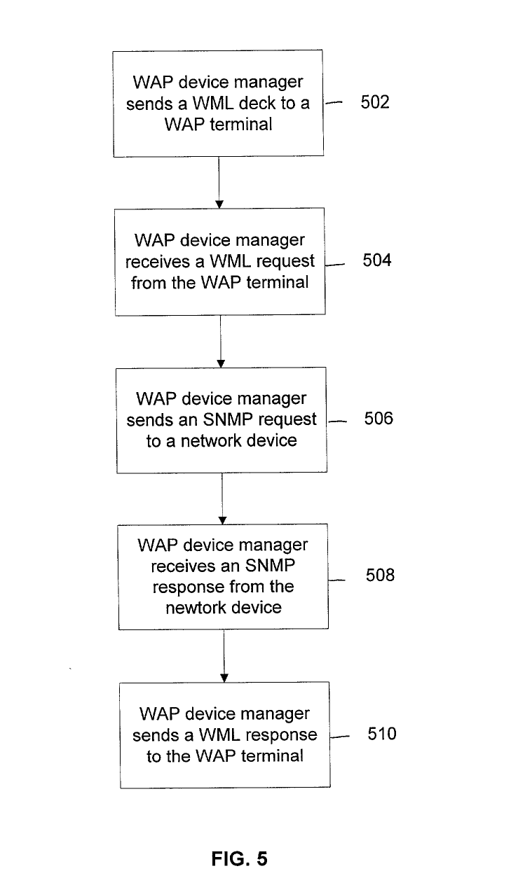

Referring to FIGS. 2-5, a method for monitoring and configuring LAN switch 12 using WAP device manager 60 and WAP terminal 50 is shown. WAP device manager 60 sends a WML user interface 54 to WAP terminal 50 (step 502, 302). Interface 54 is a WML deck of one or more cards (not shown) that may display information about and options for configuring LAN switch 12. In one example, the options are equivalent to SNMP commands available through the java applet described above.

WAP terminal 50 displays the first card of interface 54 (step 304) and permits a network administrator to navigate through interface 54 (step 306). The network administrator may send WML request 56 to WAP device manager 60 (step 308) to obtain information about LAN switch 12 or change its settings, as they would using the downloaded java applet described above.

Upon receiving WML request 56 (step 504), WAP device manager 60 sends a corresponding SNMP request 58 to LAN switch 12 over network medium 16 (step 506). LAN switch 12 receives SNMP request 58 from WAP device manager 60 (step 402) and sends SNMP response 62 to WAP device manager 60 (step 404) in reply to request 58.

Upon receiving SNMP response 62 (step 508), WAP device manager 60 sends a corresponding WML response 64 (step 510). WAP terminal 50 receives (step 310) and displays (step 312) WML response 64. In this way, WAP device manager 60 implements similar functionality as the java applet described above, yet the network administrator may manage LAN 12 from any location in which mobile telephone service is available. The smaller size and lighter weight of WAP terminal 50, as compared to a laptop computer, provides for improved portability and convenience.

Other embodiments are within the scope of the following claims.

What is claimed is:

1. A method comprising:
receiving on a wireless application protocol (WAP) terminal an interface to permit management of a network device;
interacting with the interface to send a request to a WAP device manager to manage a network device based on the request; and
at the terminal, receiving a response from the WAP device manager.

2. The method of claim 1 further comprising receiving requests from and sending responses to a wireless application protocol device manager configured to manage network devices based on requests from a wireless application protocol terminal.

3. The method of claim 2 wherein the requests and responses comply with a simple network management protocol.

4. The method of claim 1 wherein the requests and responses a re encoded in a wireless markup language.

5. The method of claim 1 wherein the terminal comprises a WAP mobile phone.

6. The method of claim 1 wherein the terminal comprises a WAP personal digital assistant.

7. The method of claim 1 wherein the device is configured to be managed by commands configured to comply with a simple network management protocol.

8. The method of claim 1 further comprising displaying the interface on the WAP terminal.

9. The method of claim 1 further comprising displaying the response on the WAP terminal.

10. A method comprising:
receiving a request from and sending a response to a wireless application protocol device manager configured to manage a network device based on a request from a wireless application protocol terminal.

11. The method of claim 10 wherein the requests and responses are configured to comply with a simple network management protocol.

12. The method of claim 10 wherein the terminal comprises a wireless application protocol cellular phone.

13. The method of claim 10 wherein the terminal comprises a wireless application protocol personal digital assistant.

14. A method comprising:
providing to a wireless application protocol terminal an interface to permit management of a network device;
sending simple network management protocol requests to the device based on wireless markup language requests received from the terminal; and
sending wireless markup language responses to the terminal based on simple network management protocol responses received from the device.

15. The method of claim 14 wherein the terminal comprises a wireless application protocol cellular phone.

16. The method of claim 14 wherein the terminal comprises a wireless application protocol personal digital assistant.

17. An article comprising:
a machine-readable medium which stores machine-executable instructions, the instructions causing a machine to:
provide to a WAP terminal an interface configured to permit management of a network device;
send simple network management protocol requests to the device based on wireless markup language requests received from the terminal; and
send wireless markup language responses to the WAP terminal based on simple network management protocol responses received from the device.

18. The article of claim 17 wherein the WAP terminal is a mobile phone.

19. The article of claim 17 wherein the WAP terminal is a personal digital assistant.

20. Apparatus comprising:
a first mechanism configured to receive a request from a WAP terminal for managing a network device and, based on the request, to send a simple network management protocol request to the network device, and
a second mechanism configured to receive a simple network management protocol response from the network device and, based on the response, to send a response to the terminal.

21. The apparatus of claim 20 wherein the request from the WAP terminal is made in a wireless markup language.

22. The apparatus of claim 20 wherein the response to the WAP terminal is made in a wireless markup language.
